(19) United States
(12) Patent Application Publication
(10) Pub. No.: US 2004/0105951 A1
(43) Pub. Date: Jun. 3, 2004

(54) Insulated coils for wires of electrical engines and magnets, especially for a motor vehicle

(76) Inventors: Thomas Voss, Langenargen (DE); Axel-Michael Muller, Friedrichshafen (DE); Wolfgang Runge, Ravensburg (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/715,704

(22) Filed: Nov. 18, 2003

(30) Foreign Application Priority Data
Nov. 28, 2002 (DE) 102 55 394.7

(51) Int. Cl. B32B 3/02

(52) U.S. Cl. 428/64.1; 242/160.1; 428/692

(57) ABSTRACT

An insulated coil for wires of electrical engines and magnets, especially for a motor vehicle, that consisting of insulated materials permitting operating temperatures above 200° C.

The present invention concerns insulated coils for wires of electrical engines and magnets, especially for a motor vehicle, according to the preamble of patent claim 1.

According to the state-of-the-art, the maximum permissible operating temperatures of wire coils for electrical engines or magnets are essentially limited by the insulating materials used, such as thermoplastics or resins. Such insulating materials not only serve to protect against contact, but also prevent the flashover of sparks or arcs between individual conductors.

Today, extra low voltages are applied to electrical engines and magnets in vehicles that amount to a maximum of 60 V, for example, for actuators and small drives. In addition, enameled wires are used that have good insulating qualities up to a voltage of at least 500 V and permit an operating temperature of approximately 200° C. This, in turn, has an effect on the dimensioning of the electrical engine or the electrical magnet, as the maximum operating temperature significantly affects the dimensioning of the components at a certain output.

The present invention is based on the task of providing an insulating material for the components of the electrical engine and magnets, especially for a motor vehicle, wherein said material facilitates an increase in the maximum operating temperature and therewith a reduction in the dimensions and the weight of the electrical engines and magnets.

This goal is achieved by the characteristics of patent claim 1. Additional designs and advantages are described in the dependent claims 2 through 4. In addition, an electrical engine and an electrical magnet are suggested that can be operated at high temperatures and, therefore, have little weight and smaller dimensions than corresponding electrical engines or magnets according to the state-of-the-art.

Accordingly, it is suggested to use insulating material for the wires of electrical engines or magnets that permit significantly higher operating temperatures for the wires that are used than the insulting materials that are used according to the state-of-the-art.

According to the invention, insulants or insulating materials should be used that act primarily as spacers for white wires as protection against contact. This is permissible with the very low voltages that are used, where there is little danger of flashovers.

It is suggested, within the framework of a preferred design, to braid wires, especially copper white wires, with glass filaments. Additionally, in a further development of the invention, the wires could be provided with an oxide layer or a ceramical-elastic thin film layer.

A significant reduction of the volume and weight of electrical engines can be achieved with the conceptual design, according to the invention, based on the increase in the maximum operating temperature and the suggested operation at high temperatures.

For example, an increase in the operating temperature of an asynchronous motor for an actuator or drive typical of a vehicle in the low voltage area of, for example, 180° C. to 280° C., leads to a reduction potential in the volume of the stator or the engine of approximately 10 percent (long “lean” engines) up to approximately 200 percent (short “fat” engines), i.e., a decrease in volume by half.

The invention will be described in greater detail with the enclosed figures illustrating the example of an asynchronous motor. They show:

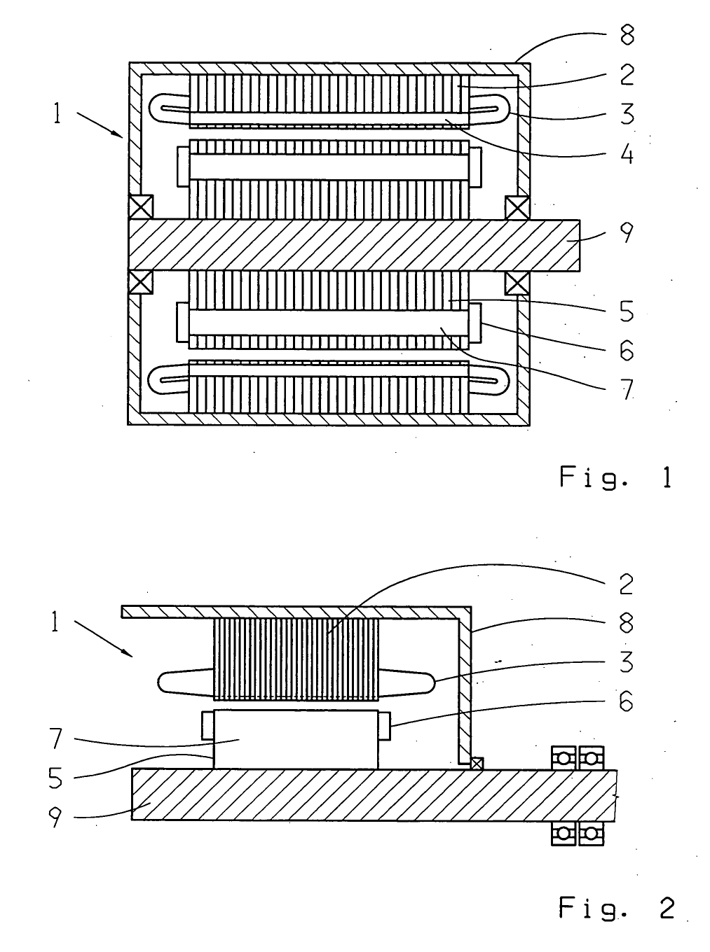

FIG. 1 is a schematic cross-section of an asynchronous engine with traditional insulating materials;

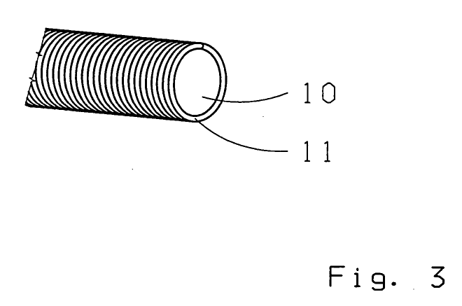

FIG. 2 is a schematic illustration of an asynchronous engine with insulating material, according to the present invention; and

FIG. 3 is a schematic illustration of a copper wire provided with the insulating material according to the present invention.

An asynchronous engine 1 is shown in FIG. 1 whose wires or wire coils are equipped with an insulating material according to the state-of-the-art, enabling a maximum operating temperature of 180° C. to 200° C. The illustrations show a stator plate 2, a winding overhand 3 with a three-phase coil 4, a rotor plate 5, a short circuit ring 6 and a cage rods 7. A housing 8 and an axis 9 consist of thermally conducting material.

On the other hand, an asynchronous engine whose wires are provided with high temperature insulation materials as spacers for protection against contact, according to the present invention, can be dimensioned significantly smaller with the same scale, as sown in FIG. 2. In contrast to the housing, according to the state-of-the-art, the housing 8 and the axis 9 are designed thermally insulating in order to guarantee operation at higher temperatures above 200° C., for example, at temperatures of 290° C. to 300° C.

The object of FIG. 3 is a copper wire 10 that has been insulated with a glass filament 11. The glass filament primarily serves, according to the invention, as a spacer for protection against contact and can be used even at temperatures above 200° C.

It is also suggested, according to the invention, to detach electrical engines operating at high temperatures from the mechanics which cannot withstand high operating temperatures.

### REFERENCE NUMERALS

1 asynchronous engine

2 stator plate

3 winding overhang

4 three-phase coil

5 rotor plate

6 short circuit ring

7 cage rods

8 housing

9 axis

10 copper wire

11 glass filament

1. Insulated coil for wires of electrical engines and magnets, especially for motor vehicles, characterized in that it consists of insulating materials permitting operating temperatures above 200° C.

2. Insulated coil according to claim 1, characterized in that—in case of low voltages—no flashover danger exists and that the insulating materials serve primarily as spacers for wires or white wires (10) for protection against contact.

3. Insulated coil according to claim 1 or 2, characterized in that the insulating material is glass filament (11).

4. Insulated coil according to claim 1 or 2, characterized in that the wires (10) have an oxide layer or a ceramic-elastic thin film layer.

5. Electrical engine or electrical magnet for a motor vehicle, characterized in that the insulated coil is an insulated coil according to one of the claims 1 to 4.

6. Electrical engine or electrical magnet according to claim 5, characterized in that the housing (8) and the axis (9) consist of thermally insulating material, for example, ceramics or plastic.

7. Electrical engine or electrical magnet according to claim 5 or 6, characterized in that they can be operated at temperatures above 200° C.
